(19) United States
(12) Patent Application Publication
(10) Pub. No.: US 2008/0248913 A1
(43) Pub. Date: Oct. 9, 2008

(54) AUTOMATIC TRANSMISSION

(75) Inventors: Takaaki Kato, Anjo-shi (JP); Tsuyoshi Fukaya, Kariya-shi (JP); Takashi Ogawa, Toyohashi-shi (JP); Akihito Hongoya, Okazaki-shi (JP); Hiroyuki Tsukamoto, Chiryu-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN AW CO., LTD., Anjo-shi (JP)

(21) Appl. No.: 12/038,369

(22) Filed: Feb. 27, 2008

(30) Foreign Application Priority Data
Feb. 28, 2007 (JP) 2007-049959

(51) Int. Cl. F16H 3/62

(52) U.S. Cl. 475/276

(57) ABSTRACT

An automatic transmission having a second ring gear of planetary gear mechanisms and is connected to an input shaft so as to be able to transmit power thereto, and a first sun gear and a second sun gear, and a first carrier that are connected to each other are in turn connected to a third control brake and a first control brake, respectively. A third sun gear and a fourth sun gear of the planetary gear mechanisms are connected to each other, and are in turn detachably connected to the input shaft 14 by a first control clutch. A third ring gear R2 and a fourth ring gear R3 are connected to a second control brake and a fourth control brake, respectively. Furthermore, a third carriers is detachably connected to the input shaft by a second control clutch, and a fourth carrier is connected to an output shaft.

### TECHNICAL FIELD

Exemplary embodiments of the present invention relate to an automatic transmission that changes the speed of the rotation of an input shaft to a plurality of stages by a planetary gear train, to transmit it to an output shaft.

### BACKGROUND ART

Conventionally, as this type of automatic transmission, for example, an automatic transmission described in Patent Document 1: Japanese Unexamined Patent Application Publication No. 2002-213545 (hereinafter referred to as “conventional automatic transmission”) is known. In this Patent Document 1, an automatic transmission that includes a dual planetary gear train for speed reduction in which a common sun gear directly connected to an input shaft meshes with a first ring gear via a small-diameter pinion with a stepped pinion provided by a carrier, and meshes with a second ring gear via a large-diameter pinion with a stepped pinion. A dual planetary gear train for speed change is provided in which a sun gear of a first single pinion planetary gear and a sun gear of a second single pinion planetary gear are directly connected to each other, and a carrier of the first single pinion planetary gear and a ring gear of the second single pinion planetary gear are directly connected to each other. A first clutch is provided that selectively connects an input shaft and the directly connected sun gear of the dual planetary gear for speed change. A second clutch selectively connects the input shaft and the directly connected carrier and ring gear of the dual planetary gear for speed change. A first brake selectively fixes the first ring gear of the dual planetary gear train for speed reduction. A second brake is provided to selectively fix the second ring gear of the dual planetary gear train for speed reduction, and a third brake that selectively fixes the carrier of the dual planetary gear train for speed reduction and the ring gear of the first single pinion planetary gear that are directly connected to each other. A fourth brake selectively fixes the directly connected carrier and ring gear of the dual planetary gear for speed change, and an output shaft that is directly connected to the carrier of the second single pinion planetary gear, changes the speed of the rotation of the input shaft to eight forward shift stages and reverse shift stage to transmit it to the output shaft.

Meanwhile, in such an automatic transmission, the increasing ratios of gear ratios (the rotational frequency of an input shaft/the rotational frequency of an output shaft) when the shift stage is raised up by one stage is called step ratios. It is desirable that the step ratios are distributed without any large variation at every shift stage from the viewpoint that a good indication of speed change is obtained. Further, if the values of the step ratios themselves at respective shift stages are excessively small ((that is, values near “1”), the drop of the rotational frequency within the range of effective rotation of an engine becomes slight, for example, at the time of speed change accompanied by acceleration. Therefore, a feeling or indication of speed change becomes weak, and a driver cannot obtain a sufficient feeling of acceleration at the time of speed change.

In this regard, in the conventional automatic transmission, the step ratio between a fourth shift stage and a fifth shift stage and the step ratio between the fifth shift stage and a sixth shift stage have large variations as compared with the step ratios between those shift stages, and respective shift stages adjacent thereto at the low-speed side and high-speed side. Moreover, the step ratio between the sixth shift stage and a seventh shift stage that are high-speed stages becomes a small step ratio less than 1.1 at which it is not possible to expect to provide an indication of speed change. Accordingly, an automatic transmission is needed that has step ratios distributed properly and having gear ratios of forward eight stages, capable of obtaining a sufficient feeling of acceleration as a clear indicative of speed change at the time a speed change is accompanied by acceleration.

The invention has been made in view of such circumstances, and an aspect of the invention is to provide an automatic transmission capable of obtaining a sufficient feeling of acceleration as a clear indication of speed change at the time speed change is accompanied by acceleration. Accordingly, in the invention, the step ratios between respective shift stages is properly distributed.

### SUMMARY OF THE INVENTION

Aspects of the present invention relate to an automatic transmission including a dual planetary gear train for speed change having a first planetary gear mechanism and a second planetary gear mechanism both of which is of a single pinion type, and a dual planetary gear train for speed reduction having a third planetary gear mechanism and a fourth planetary gear mechanism both of which is of a single pinion type.

In the dual planetary gear train for speed reduction, the first planetary gear mechanism is configured so as to include a first sun gear, a first carrier that bears a first pinion that meshes with the first sun gear, and a first ring gear that meshes with the first pinion, the second planetary gear mechanism is configured so as to include a second sun gear that is connected to the first sun gear, a second carrier that bears the second pinion that meshes with the second sun gear, and that is connected to the first ring gear, and a second ring gear that meshes with the second pinion, the second ring gear is connected to an input shaft so as to be able to transmit power thereto, the first sun gear and the second sun gear that are connected to each other are connected to the third control brake, and the first carrier is connected to the first control brake. In the dual planetary gear train for speed change, the third planetary gear mechanism is configured so as to include a third sun gear, a third carrier that bears a third pinion that meshes with the third gear, and a third ring gear that meshes with the third pinion, and is connected to both the second carrier and the first ring gear so as to be able to transmit power thereto. The fourth planetary gear mechanism is configured so as to include a fourth sun gear, a fourth carrier that bears a fourth pinion that meshes with the fourth sun gear, and a fourth ring gear that meshes with the fourth pinion, and is connected to the third carrier. The third sun gear and the fourth sun gear are connected to each other, and are detachably connected to the input shaft by a first control clutch. The third ring gear and the fourth ring gear are connected to a second control brake and a fourth control brake, respectively, where the third carrier is detachably connected to the input shaft by a second control clutch, and the fourth carrier is connected to an output shaft. Furthermore, rotation of the first ring gear and the second carrier is transmitted to the third ring gear.

According to a non-limiting embodiment of the, the step ratios that are the increasing ratios of gear ratios (the rotational frequency of an input shaft/the rotational frequency of an output shaft) when the shift stage is raised up by one stage is distributed without any large deviation at every shift stage. Further, the values of step ratios at respective shift stage become values that are separated from “1”, i.e., values larger than 1.1 at which it is possible to expect to provide an indication of speed change. Accordingly, by properly distributing the step ratios between the respective shift stages, a sufficient feeling of acceleration can be obtained as a clear indication of speed change at the time of speed change accompanied by acceleration.

In a further non-limiting embodiment, a third control clutch for preventing the high-speed rotation of the first sun gear and the second sun gear is provided.

According to a non-limiting embodiment, a situation in which the first sun gear and the second sun gear that are connected to each other is reversely rotated at very high speed can be avoided by disconnecting the third control clutch at the time of predetermined shift change.

Further, in a non-limiting embodiment, the third control clutch selectively connects the input shaft and the second ring gear.

In yet another non-limiting embodiment, the third control clutch selectively connects the first ring gear and the second carrier, and the third ring gear.

### BRIEF DESCRIPTION OF THE DRAWINGS

Aspects of the present invention will become more apparent by describing in detail non-limiting embodiments thereof with reference to the attached drawings, in which:

FIG. 1 is a skeleton view of an automatic transmission of a first, non-limiting embodiment,

FIG. 2 is an operation table of control clutches and control brakes at respective shift stages of the automatic transmission,

FIG. 3 is a speed diagram showing gear ratios of respective elements of planetary gear trains at respective shift stages of the automatic transmission,

FIG. 4 is a skeleton view of an automatic transmission of a second, non-limiting embodiment,

FIG. 5 is a speed diagram showing gear ratios of respective elements of planetary gear trains at respective shift stages of the automatic transmission,

FIG. 6 is a skeleton view of an automatic transmission of a third, non-limiting embodiment,

FIG. 7 is an operation table of control clutches and control brakes at respective shift stages of the automatic transmission,

FIG. 8 is a speed diagram showing gear ratios of respective elements of planetary gear trains at respective shift stages of the automatic transmission,

FIG. 9 is a skeleton view of an automatic transmission of an alternative, non-limiting embodiment,

FIG. 10 is a skeleton view of an automatic transmission of an alternative, non-limiting embodiment,

FIG. 11 is a skeleton view of an automatic transmission of an alternative, non-limiting embodiment,

FIG. 12 is a skeleton view of an automatic transmission of an alternative, non-limiting embodiment,

FIG. 13 is a skeleton view of an automatic transmission of an alternative, non-limiting embodiment,

FIG. 14 is a skeleton view of an automatic transmission of an alternative, non-limiting embodiment,

FIG. 15 is a skeleton view of an automatic transmission of an alternative, non-limiting embodiment,

FIG. 16 is a skeleton view of an automatic transmission of an alternative, non-limiting embodiment, and

FIG. 17 is a skeleton view of an automatic transmission of an alternative, non-limiting embodiment.

### DETAILED DESCRIPTION OF EXEMPLARY EMBODIMENTS OF THE INVENTION

The following description of illustrative, non-limiting embodiments of the invention discloses specific configurations and components. However, the embodiments are merely examples of the present invention and, thus, the specific features described below are merely used to more easily describe such embodiments and to provide an overall understanding of the present invention. Accordingly, one skilled in the art will readily recognize that the present invention is not limited to the specific embodiments described below. Furthermore, the descriptions of various configurations, components, processes and operations of the embodiments that are known to one skilled in the art are omitted for the sake of clarity and brevity.

### First Embodiment

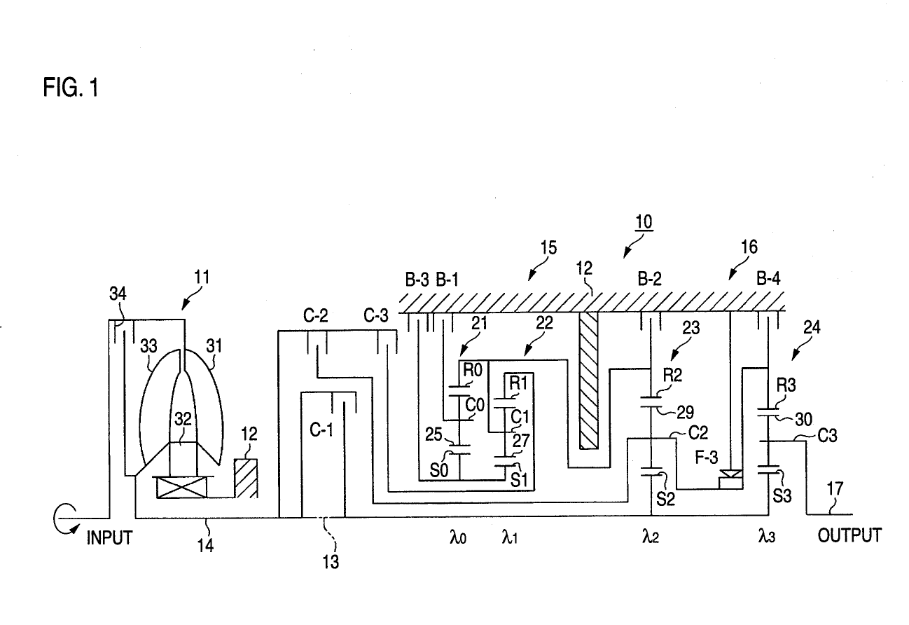

Hereinafter, a first non-limiting embodiment of an automatic transmission according to the invention will be explained referring to FIGS. 1 to 3.

FIG. 1 shows a skeleton view of the automatic transmission 10 of this embodiment. The automatic transmission 10 is used in order to change and transmit the speed of the output rotation of the hydraulic torque converter 11, which is rotationally driven by, for example, an engine of an automobile, to driving wheels. As shown in FIG. 1, the automatic transmission 10 includes a transmission case 12 attached to a vehicle body, an input shaft 14, a dual planetary gear train 15 for speed reduction, and a dual planetary gear train 16 for speed change, and an output shaft 17, which are provided sequentially (from the left to the right in FIG. 1) from the front to the rear at a common axis 13 passing through almost the center in the transmission case 12.

As shown in FIG. 1, in the dual planetary gear train 15 for speed reduction, a single-pinion-type first planetary gear mechanism 21 is disposed at a front stage, and the same single-pinion-type second planetary gear mechanism 22 is disposed at a rear stage. Further, in the dual planetary gear train 16 for speed change, a single-pinion-type third planetary gear mechanism 23 is disposed at a front stage, and the same single-pinion-type fourth planetary gear mechanism 24 is disposed at a rear stage.

First, a concrete configuration of the dual planetary gear train 15 for speed reduction will be explained.

In the dual planetary gear train 15 for speed reduction, the first planetary gear mechanism 21 at the front stage includes a first sun gear S0 rotatably provided on the common axis 13, a first carrier C0 that rotatably bears a first pinion 25 that meshes with the first sun gear S0, and is rotatably provided on the common axis 13, and a first ring gear R0 that meshes with the first pinion 25 and is rotatably provided on the common axis 13.

The second planetary gear mechanism 22 at the rear stage includes a second sun gear S1 that is connected to the first sun gear S0, and is rotatably provided on the common axis 13, a second carrier C1 that rotatably bears a second pinion 27 that meshes with the second sun gear S1, is connected to the first ring gear R0, and is rotatably provided on the common axis 13, and a second ring gear R1 that meshes with the second pinion 27 and is rotatably provided on the common axis 13.

In the dual planetary gear train 15 for speed reduction, the second ring gear R1 is detachably connected to the input shaft 14 by a third control clutch C-3. That is, the third control clutch C-3 is provided on a power transmission path so that power can be transmitted to the dual planetary gear train 16 for speed change via the dual planetary gear train 15 for speed reduction from the input shaft 14. In a case where the third control clutch C-3 is connected, the second ring gear R1 is connected to the input shaft 14 so that it can transmit power. Further, the first sun gear S0, and the second sun gear S1 and the first carrier C0 that are connected to each other are respectively connected to a third control brake B-3 and a first control brake B-1 that are provided in the transmission case 12, and the rotation of each thereof is regulated in a case where the control brakes B-3 and B-1 have operated.

Next, a concrete configuration of the dual planetary gear train 16 for speed change will be explained.

In the dual planetary gear train 16 for speed change, the third planetary gear mechanism 23 at the front stage includes a third sun gear S2 rotatably provided on the common axis 13, and a third carrier C2 that rotatably bears a third pinion 29 that meshes with the third sun gear S2 and is rotatably provided on the common axis 13. Furthermore, the third planetary gear mechanism 23 includes a third ring gear R2 that meshes with the third pinion 29, is connected to the both the second carrier C1 of the second planetary gear mechanism 22 and the first ring gear R0 of the first planetary gear mechanism 21, in the dual planetary gear train 15 for speed reduction, and is rotatably provided on the common axis 13.

The fourth planetary gear mechanism 24 at the rear stage includes a fourth sun gear S3 rotatably provided on the common axis 13, and a fourth carrier C3 that bears a fourth pinion 30 that meshes with the fourth sun gear S3, and is rotatably provided on the common axis 13. Furthermore, the fourth planetary gear mechanism 24 includes a fourth ring gear R3 that meshes with the fourth pinion 30, is connected to the third carrier C2 of the third planetary gear mechanism 23 at the front stage, and is rotatably provided on the common axis 13.

In the dual planetary gear train 16 for speed change, the third sun gear S2 and the fourth sun gear S3 are detachably connected to the input shaft 14 by a first control clutch C-1 in a state where they are connected to each other, and the third carrier C2 and the fourth ring gear R3 are detachable connected to the input shaft 14 by a second control clutch C-2 in a state where they are connected to each other. Further, a one-way clutch F-3 provided in the transmission case 12 regulates the rotation (reverse rotation) of the fourth ring gear R3 in one direction along with the third carrier C2 of the third planetary gear mechanism 23 at the front stage, and the fourth carrier C3 is connected to the output shaft 17. Further, the third ring gear R2 and the fourth ring gear R3 are respectively connected to a second control brake B-2 and a fourth control brake B-4 provided in the transmission case 12, and the rotation of each thereof is regulated is regulated, in a case where the control brakes B-2 and B-4 have operated.

Further, a hydraulic torque converter 11 shown in FIG. 1 generates torque in a turbine 33 as a pump impeller 31 is rotationally driven by an engine (not shown) to deliver oil, and a stator 32 receives the reaction force of the oil. In addition, in a case where a lock-up clutch 34 operates, the pump impeller 31 and the turbine 33 are directly connected via a lock-up clutch 34. Therefore, even in this case, torque will be generated in the turbine 33. The input shaft 14 is connected to the turbine 33 so that power may be transmitted to the output shaft 17 through any power transmission path among a plurality of power transmission paths from the input shaft 14 side.

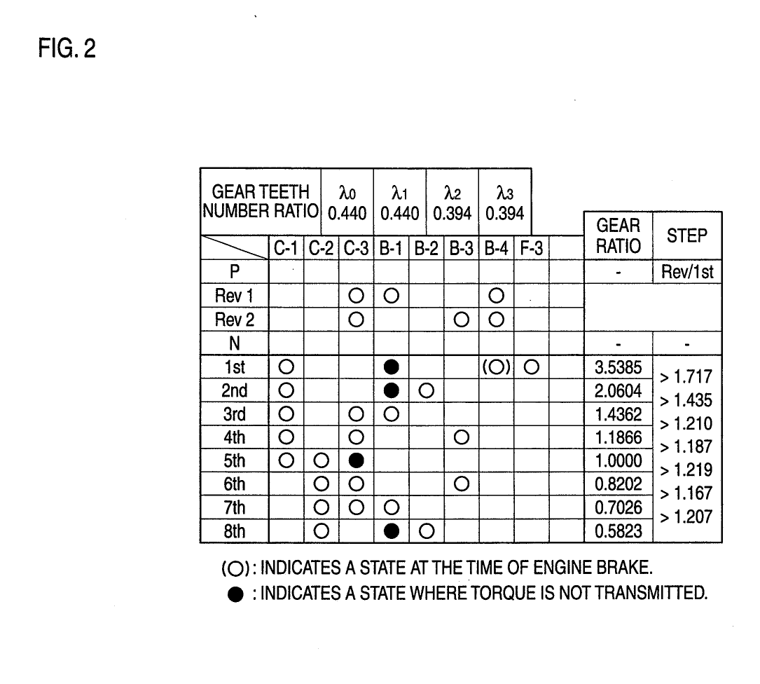

Now, in the automatic transmission 10 configured as described above, the respective first to third control clutches C-1 to C-3, and the respective first to fourth control brakes B-1 to B-4 operate to be engaged and disengaged selectively, and the rotation of respective elements (sun gear, ring gear, etc.) of the dual planetary gear train 15 for speed reduction and the dual planetary gear train 16 for speed change is regulated, thereby establishing the gear ratios of eight forward stages and two reverse stages. Thus, the operating state of the respective first to third control clutches C-1 to C-3 and the respective first to fourth control brakes B-1 to B-4 at respective shift stages (eight forward stages and two reverse stages) at the time of the speed change of the automatic transmission 10 will be explained below with reference to FIG. 2.

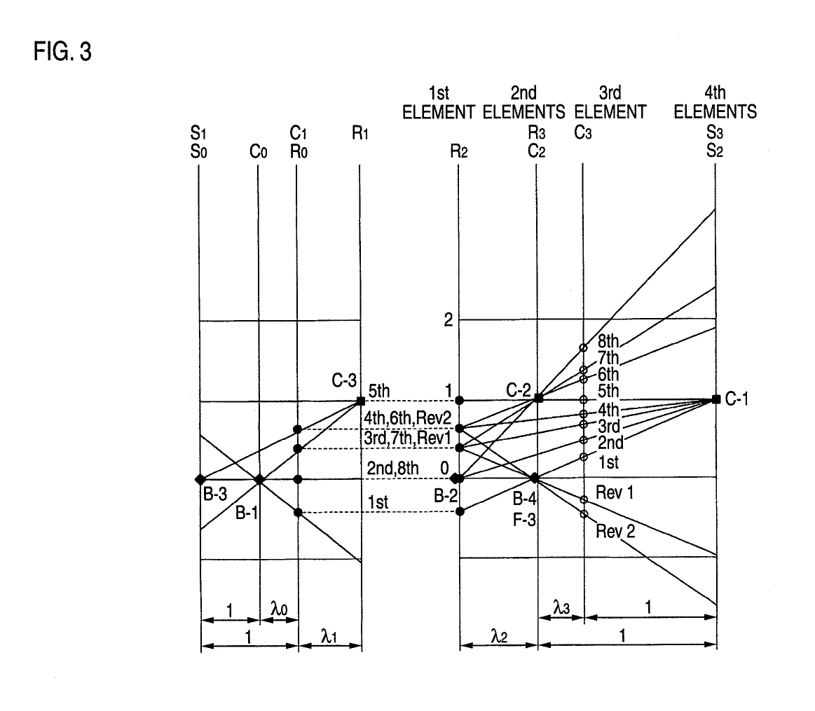

In FIG. 2, along with the operating state of the control clutches and the like at the respective shift stages, gear ratios (the rotational frequency of the input shaft 14/the rotational frequency of the output shaft 17), and step ratios showing increasing ratios (the gear ratio of the present shift stage/the gear ratio of the previous shift stage) when the shift stage is raised up by one stage are shown on the right of the table. In addition, in the operation table of FIG. 2, in a case where white circles are given to columns of the respective control clutches and control brakes corresponding to the respective gear ratios, they indicate that the control clutches are in a connected state, and the control brakes are in a rotation-regulated state. However, as annotated below the operation table, in a case where a white circle with parentheses is given, it indicates that any relevant control clutch and control brake are in a connected state and a rotation-regulated state at the time of engine brake. Further, in a case where a black circle is given, it indicates that any relevant control clutch and control brake are not involved in torque transmission (power transmission) although engaged. the respective control clutches C-1 to C-3 and the respective control brakes B-1 to B-4 operate to be engaged and disengaged selectively as shown in the operation table of FIG. 2, the speed ratios of respective elements (sun gear, ring gear, etc.) of the respective planetary gear mechanisms 21 to 24 in the respective planetary gear trains 15 and 16 become as shown in the speed diagram shown in FIG. 3. That is, in this speed diagram, the respective elements composed of the sun gears S0 to S3, carriers C0 to C3, and ring gears R0 to R3 of the respective planetary gear trains 15 and 16 are arranged at intervals corresponding to the gear tooth numbers λ0 to λ3 in the direction of a horizontal axis, and the speed ratios corresponding to the respective elements are taken in the direction of a vertical axis. In the speed diagram of FIG. 3, the respective speed diagrams of the dual planetary gear train 15 for speed reduction and the dual planetary gear train 16 for speed change are shown parallel to each other on the right and left.

First, in the left speed diagram of the dual planetary gear train 15 for speed reduction, the second sun gear S1 and the first sun gear S0, and the second carrier C1 and first ring gear R0 are connected to and shared by each other, respectively. Thus, the respective speed ratios of the second sun gear S1 and the first sun gear S0, and the second carrier C1 and the first ring gear R0 are represented on respective vertical lines to which S1, S0 and C1, R0 are given, respectively. Further, the respective speed ratios of the first carrier C0 and the second ring gear R1 are represented on one vertical line to which C0, R1 are given, respectively. In both the single-pinion-type first planetary gear mechanism 21 and second planetary gear mechanism 22, the interval between the vertical line of each of the carriers C0, C1 and the vertical line of each of the sun gears S0, S1 is defined as “1”, and the vertical lines of the respective ring gears R0, R1 are arranged on the side opposite the vertical lines of the respective sun gears S0, S1 from the vertical lines of the respective carriers C0, C1 so as to be spaced by intervals corresponding to the gear tooth numbers λ0, λ1.

On the other hand, in the right speed diagram of the dual planetary gear train 16 for speed change, the fourth ring gear R3 and the third carrier C2, and the fourth sun gear S3 and the third sun gear S2 are connected to and shared by each other, respectively. Thus, the speed ratios of the fourth ring gear R3 and the third carrier C2, and the fourth sun gear S3 and the third sun gear S2 are represented on respective vertical lines to which R3, C2 and S3, S2 are given, respectively. Further, the respective speed ratios of the third ring gear R2 and the fourth carrier C3 are represented on one vertical line to which R2, C3 are given, respectively. In both the single-pinion-type third planetary gear mechanism 23 and fourth planetary gear mechanism 24, the interval between the vertical line of each of the carriers C2, C3, and the vertical line of each of the sun gears S2, S3 is defined as “1”, and the vertical lines of the respective ring gears R2, R3 are arranged on the side opposite the vertical lines of the respective sun gears S2, S3 from the vertical lines of the respective carriers C2, C3 so as to be spaced by intervals corresponding to the gear tooth numbers λ2, λ3.

Further, in the speed diagram of FIG. 3, symbols of B-1 to B-4 and C-1 to C-3 are given to points where the respective first to fourth control brakes B-1 to B-4, and the respective first to third control clutches C-1 to C-3 are selectively operated. Further, power transmission paths at respective shift stages are shown between the left speed diagram of the dual planetary gear train 15 for speed reduction and the right speed diagram of the dual planetary gear train 16 for speed change, by connecting and representing the elements corresponding to each other by broken lines in a case where power is transmitted at the respective shift stages.

Further, in the right speed diagram of the dual planetary gear train 16 for speed change, the elements corresponding to the respective four vertical lines are defined as first, second, third, and fourth elements in an alignment sequence of the vertical lines. The third ring gear R2 serving as the first element is connected to both the second carrier C1 and the first ring gear R0 of the dual planetary gear train 15 for speed reduction, the fourth ring gear R3 and the third carrier C2 serving as the second element, which are connected to each other, are connected in parallel with the second control clutch C-2 and the fourth control brake B-4 in a state where the rotation (reverse rotation) thereof in one direction is regulated by the one-way clutch F-3. Further, the fourth carrier C3 serving as the third element is connected to the output shaft 17, and the fourth sun gear S3 and the third sun gear S2 serving as the fourth element are detachably connected to the input shaft 14 by the first control clutch C-1 in a state where they are connected to each other.

Thus, next, the operation of respective shift stages in the automatic transmission 10 configured as described above will be explained paying attention to the operating state at the time of speed change, referring to FIG. 2.

First, in the case of a forward first shift stage, the third sun gear S2 and the fourth sun gear S3 are connected to the input shaft 14 by the operation of the first control clutch C-1, and the rotation of the input shaft 14 is transmitted to the third sun gear S2 and the fourth sun gear S3. In this case, since the reverse driving of the fourth ring gear R3 is regulated by the operation of the one-way clutch F-3, the fourth pinion 30 that meshes with the fourth sun gear S3 is supported in reaction force by the fourth ring gear R3 whose reverse driving is regulated, and revolves therearound, and the fourth carrier C3 serving as the third element that bears the fourth pinion 30 rotates. As a result, the output shaft 17 connected to the fourth carrier C3 is normally driven at a gear ratio 3.5385 of the forward first shift stage shown in FIG. 2. In addition, at the time of engine brake, the one-way clutch F-3 revolves, and thereby the reverse driving of the fourth ring gear R3 can not be regulated. Thus, in this case, the fourth control brake B-4 operates to regulate the rotation of the fourth ring gear R3 to permit the rotation of the fourth pinion 30 so that the fourth carrier C3 and the output shaft 17 may be rotated.

Next, in the case of a forward second shift stage, the third sun gear S2 and the fourth sun gear S3 are connected to the input shaft 14 by the operation of the first control clutch C-1, and the rotation of the input shaft 14 is transmitted to the third sun gear S2 and the fourth sun gear S3. In this case, since the rotation of the third ring gear R2 is regulated by the operation of the second control brake B-2, the third pinion 29 that meshes with the third sun gear S2 is supported in reaction force by the third ring gear R2, and revolves therearound, and the third carrier C2 and the fourth ring gear R3 are rotated. Then, the fourth pinion 30 revolves according to the rotational difference between the fourth ring gear R3 and the fourth sun gear S3, and the fourth carrier C3 serving as the third element that bears the fourth pinion 30 rotates. As a result, the output shaft 17 connected to the fourth carrier C3 is normally driven at a gear ratio 2.0604 of the forward second shift stage shown in FIG. 2.

Next, in the case of a forward third shift stage, the third sun gear S2 and the fourth sun gear S3 are connected to the input shaft 14 by the operation of the first control clutch C-1, and the rotation of the input shaft 14 is transmitted to the third sun gear S2 and the fourth sun gear S3. Further, the second ring gear R1 is connected to the input shaft 14 by the operation of the third control clutch C-3, and the rotation of the input shaft 14 is transmitted even to the second ring gear R1. In this case, the rotation of the first carrier C0 is regulated by the operation of the first control brake B-1. Thus, with the rotation of the second ring gear R1, the second carrier C1 that rotatably bears the second pinion 27, along with the first ring gear R0 connected thereto, is supported in reaction force by the first carrier C0, and revolves therearound. With the rotation of the first ring gear R0 and the second carrier C1, the third ring gear R2 connected to both the first ring gear R0 and the second carrier C1 also rotate.

Then, the third pinion 29 revolves according to the rotational difference between the third ring gear R2 and the third sun gear S2, and the third carrier C2 and the fourth ring gear R3 are rotated. Then, the fourth pinion 30 revolves according to the rotational difference between the fourth ring gear R3 and the fourth sun gear S3, and the fourth carrier C3 serving as the third element that bears the fourth pinion 30 rotates. As a result, the output shaft 17 connected to the fourth carrier C3 is normally driven at a gear ratio 1.4362 of the forward third shift stage shown in FIG. 2.

Next, in the case of a forward fourth shift stage, the third sun gear S2 and the fourth sun gear S3 are connected to the input shaft 14 by the operation of the first control clutch C-1, and the rotation of the input shaft 14 is transmitted to the third sun gear S2 and the fourth sun gear S3. Further, the second ring gear R1 is connected to the input shaft 14 by the operation of the third control clutch C-3, and the rotation of the input shaft 14 is transmitted even to the second ring gear R1. In this case, the rotation of the first sun gear S0 and the second sun gear S1 that are connected to each other is regulated by the operation of the third control brake B-3. Thus, with the rotation of the second ring gear R1, the second pinion 27 is supported in reaction force by the second sun gear S2, and revolves therearound, and the second carrier C1 that rotatably bears the second pinion 27 rotates along with the third ring gear R2 connected thereto.

Then, according to the rotational difference between the third ring gear R2 and the third sun gear S2, the third pinion 29 revolves. When the third carrier C2 and the fourth ring gear R3 rotate with the revolution of the third pinion 29, the fourth pinion 30 revolves according to the rotational difference between the fourth ring gear R3 and the fourth sun gear S3, and the fourth carrier C3 serving as the third element that bears the fourth pinion 30 rotates. As a result, the output shaft 17 connected to the fourth carrier C3 is normally driven at a gear ratio 1.1866 of the forward fourth shift stage shown in FIG. 2.

Next, in the case of a forward fifth shift stage, the third sun gear S2 and the fourth sun gear S3 are connected to the input shaft 14 by the operation of the first control clutch C-1, and the rotation of the input shaft 14 is transmitted to the third sun gear S2 and the fourth sun gear S3. Further, by the operation of the second control clutch C-2, the third carrier C2 and the fourth ring gear R3 that are connected to each other are connected to the input shaft 14, and the rotation of the input shaft 14 is transmitted even to the third carrier C2 and the fourth ring gear R3. As a result, the fourth sun gear S3, and the fourth carrier C3 serving as the third element that bears the fourth pinion 30 that meshes with the fourth ring gear R3 also rotate integrally, and the output shaft 17 connected to the fourth carrier C3 is normally driven at a gear ratio 1.0000 of the forward fifth shift stage shown in FIG. 2.

Next, in the case of a forward sixth shift stage, by the operation of the second control clutch C-2, the third carrier C2 and the fourth ring gear R3 that are connected to each other are connected to the input shaft 14, and the rotation of the input shaft 14 is transmitted to the third carrier C2 and the fourth ring gear R3. Further, the second ring gear R1 is connected to the input shaft 14 by the operation of the third control clutch C-3, and the rotation of the input shaft 14 is transmitted even to the second ring gear R1. In this case, the rotation of the first sun gear S0 and the second sun gear S1 that are connected to each other is regulated by the operation of the third control brake B-3. Thus, with the rotation of the second ring gear R1, the second pinion 27 is supported in reaction force by the second sun gear S2, and revolves therearound, and the second carrier C1 that rotatably bears the second pinion 27 rotates along with the third ring gear R2 connected thereto.

Then, according to the rotational difference between the third ring gear R2 and the third carrier C2, the third sun gear S2 rotates along with the fourth sun gear S3 connected thereto. Then, the fourth pinion 30 revolves according to the rotational difference between the fourth sun gear S3 and the fourth ring gear R3, and the fourth carrier C3 serving as the third element that bears the fourth pinion 30 rotates. As a result, the output shaft 17 connected to the fourth carrier C3 is normally driven at a gear ratio 0.8202 of the forward sixth shift stage shown in FIG. 2.

Next, in the case of a forward seventh shift stage, by the operation of the second control clutch C-2, the third carrier C2 and the fourth ring gear R3 that are connected to each other are connected to the input shaft 14, and the rotation of the input shaft 14 is transmitted to the third carrier C2 and the fourth ring gear R3. Further, the second ring gear R1 is connected to the input shaft 14 by the operation of the third control clutch C-3, and the rotation of the input shaft 14 is transmitted even to the second ring gear R1. In this case, the rotation of the first carrier C0 is regulated by the operation of the first control brake B-1. Thus, with the rotation of the second ring gear R1, the second carrier C1 that rotatably bears the second pinion 27, along with the first ring gear R0 connected thereto, is supported in reaction force by the first carrier C0, and revolves therearound. With the rotation of the first ring gear R0 and the second carrier C1, the third ring gear R2 connected to both the first ring gear R0 and the second carrier C1 also rotate.

Then, according to the rotational difference between the third ring gear R2 and the third carrier C2, the third sun gear S2 rotates along with the fourth sun gear S3 connected thereto. Then, the fourth pinion 30 revolves according to the rotational difference between the fourth sun gear S3 and the fourth ring gear R3, and the fourth carrier C3 serving as the third element that bears the fourth pinion 30 rotates. As a result, the output shaft 17 connected to the fourth carrier C3 is normally driven at a gear ratio 0.7026 of the forward seventh shift stage shown in FIG. 2.

Next, in the case of a forward eighth shift stage, by the operation of the second control clutch C-2, the third carrier C2 and the fourth ring gear R3 that are connected to each other are connected to the input shaft 14, and the rotation of the input shaft 14 is transmitted to the third carrier C2 and the fourth ring gear R3. In this case, the rotation of the third ring gear R2 is regulated by the operation of the second control brake B-2. Thus, the third sun gear S2 rotates along with the fourth sun gear S3 connected thereto, the fourth pinion 30 revolves according to the rotational difference between the fourth sun gear S3 and the fourth ring gear R3, and the fourth carrier C3 serving as the third element that bears the fourth pinion 30 rotates. As a result, the output shaft 17 connected to the fourth carrier C3 is normally driven at a gear ratio 0.5823 of the forward eighth shift stage shown in FIG. 2.

Next, in the case of a reverse first shift stage, the second ring gear R1 is connected to the input shaft 14 by the operation of the third control clutch C-3, and the rotation of the input shaft 14 is transmitted to the second ring gear R1. In this case, the rotation of the first carrier C0 is regulated by the operation of the first control brake B-1. Thus, with the rotation of the second ring gear R1, the second carrier C1 that rotatably bears the second pinion 27, along with the first ring gear R0 connected thereto, is supported in reaction force by the first carrier C0, and revolves therearound. With the rotation of the first ring gear R0 and the second carrier C1, the third ring gear R2 connected to both the first ring gear R0 and the second carrier C1 also rotate.

In this case, since the rotation of the fourth ring gear R3 and the third carrier C2 that are connected to each other is regulated by the operation of the fourth control brake B-4, the third sun gear S2 is reversely rotated together with the fourth sun gear S3 connected thereto via the third pinion 29 that is provided by the third carrier C2. Then, the fourth pinion 30 that meshes with the fourth sun gear S3 is supported in reaction force by the fourth ring gear R3, and revolves therearound, and the fourth carrier C3 serving as the third element that bears the fourth pinion 30 rotates. As a result, the output shaft 17 connected to the fourth carrier C3 is reversely driven at a predetermined gear ratio of the reverse first shift stage.

Next, in the case of a reverse second shift stage, the second ring gear R1 is connected to the input shaft 14 by the operation of the third control clutch C-3, and the rotation of the input shaft 14 is transmitted to the second ring gear R1. In this case, the rotation of the first sun gear S0 and the second sun gear S1 that are connected to each other is regulated by the operation of the third control brake B-3. Thus, with the rotation of the second ring gear R1, the second pinion 27 is supported in reaction force by the second sun gear S2, and revolves therearound, and the second carrier C1 that rotatably bears the second pinion 27 rotates along with the third ring gear R2 connected thereto.

In this case, since the rotation of the fourth ring gear R3 and the third carrier C2 that are connected to each other is regulated by the operation of the fourth control brake B-4, the third sun gear S2 is reversely rotated by the fourth sun gear S3 connected thereto via the third pinion 29 that is provided by the third carrier C2. Then, the fourth pinion 30 that meshes with the fourth sun gear S3 is supported in reaction force by the fourth ring gear R3, and revolves therearound, and the fourth carrier C3 serving as the third element that bears the fourth pinion 30 rotates. As a result, the output shaft 17 connected to the fourth carrier C3 is reversely driven at a predetermined gear ratio of the reverse second shift stage.

In addition, in the aforementioned forward first shift stage, the third ring gear R2 rotates reversely rotates according to the rotation of the third sun gear S2. However, the second carrier C1 and the first ring gear R0 that are connected to the third ring gear R2 also rotate reversely. Therefore, in a case where the third control clutch C-3 is not provided, the rotation of the input shaft 14 is transmitted even to the second ring gear R1, thereby causing a large relative rotational difference between the second ring gear R1 and the second carrier C1. As a result, the second sun gear S1 that meshes with the second pinion 27 that is provided by the second carrier C1 will rotate at very high speed along the second sun gear S0 connected thereto. However, in the case of the automatic transmission 10 of this embodiment, the third control clutch C-3 is provided, and the third control clutch C-3 is disconnected at the forward first shift stage. Therefore, the very high-speed rotation of the first sun gear S0 and the second sun gear S1 as described above is avoided.

In the automatic transmission 10 of this non-limiting embodiment, the respective shift stages are brought into the operating states as described above at the time of speed change, and the rotation ratios of the respective sun gears S0 to S3, the respective carriers C0 to C3, and the respective ring gears R0 to R3 at respective shift stages in a case where the rotational frequency of the input shaft 14 is defined as “1” are shown in the speed diagram of FIG. 3. Therefore, as apparent from the speed diagram of FIG. 3, the gear ratios of the forward eight stages and reverse two stages that are arrayed at proper intervals without any large variation in the rotation ratio, i.e., gear ratio of the fourth carrier C3 that is the third element at the respective shift stages, and that are separated suitably can be realized.

Moreover, the step ratios that are increasing ratios of the gear ratios when the shift stage is raised up by one stage, as shown in FIG. 2, become 1.717 between the first and second shift stages, 1.435 between the second and third shift stages, 1.210 between the third and fourth shift stages, 1.187 between the fourth and fifth shift stages, 1.219 between the fifth and sixth shift stages, 1.167 between the sixth and seventh shift stages, and 1.207 between the seventh and eighth shift stages. That is, the step ratios are also distributed without any large variation for every shift stage. With respect to the values of the step ratios at the respective shift stages, even the value of the step ratio between the sixth and seventh shift stages that is a minimum value among the step ratios becomes 1.167.

Accordingly, according to the automatic transmission 10 of this embodiment, the following effects can be obtained.

(1) The step ratios at the respective shift stages of the forward eight stages are distributed without any large variation for every shift stage. Further, with respect to the values of the step ratios at the respective shift stages, even the value of the step ratio between the sixth and seventh shift stages is 1.167 that is a minimum value of the step ratios. The values become values that are separated from “1”, i.e., values larger than 1.1 at which it is possible to expect to provide an indication of speed change. Accordingly, by properly distributing the step ratios between the respective shift stages, a sufficient feeling of acceleration can be obtained as a clear indication of speed change at the time of speed change accompanied by acceleration.

(2) Further, at the time of speed change of the forward first shift stage, the third control clutch C-3 is disconnected, and the second ring gear R1 and the second carrier C1 do not rotate with a large relative rotational difference. Thus, it is possible to avoid a situation in which the second sun gear S1 that meshes with the second pinion 27 that is provided by the second carrier C1 is reversely rotated at very high speed by the first sun gear S0 connected to thereto.

(3) Further, the third control clutch C-3 can be arranged nearer to the front than a place where each of the planetary gear trains 15 and 16 is arranged, within the transmission case 12. Therefore, an oil passage can be formed within the input shaft 14 along the common axis 13, thereby supplying operating oil to the third control clutch C-3 via the oil passage, and the oil passage for the supply of the operating oil to the third control clutch C-3 is easily secured.

### Second Embodiment

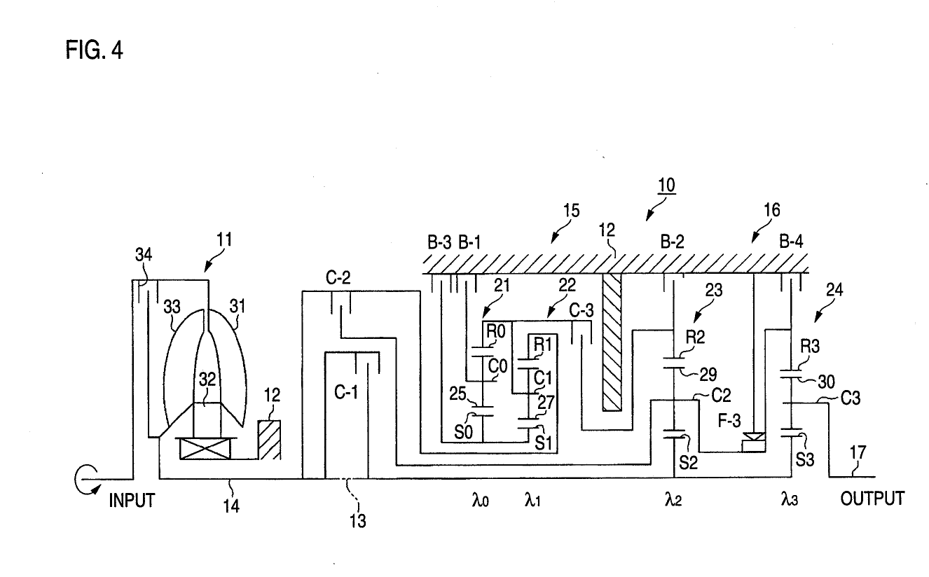

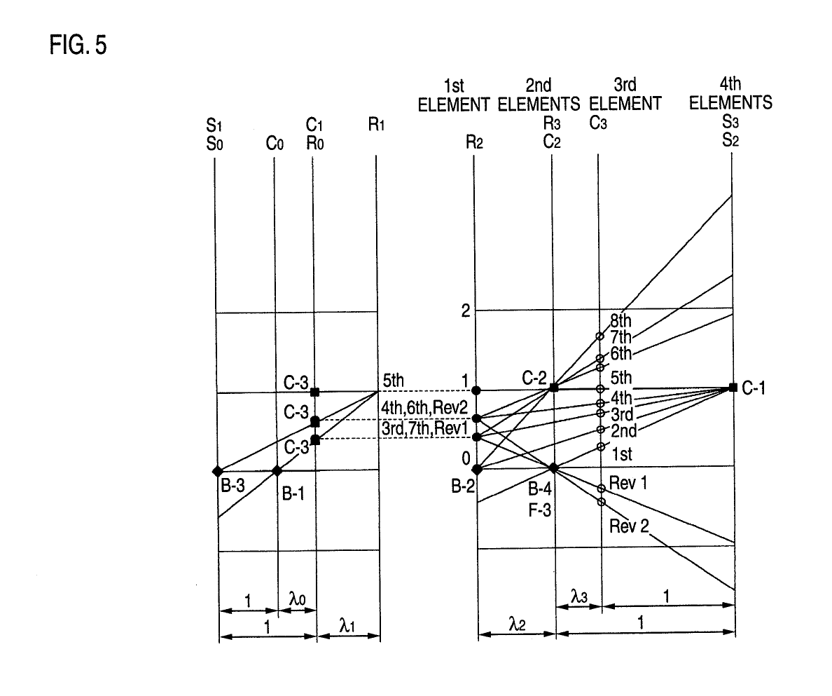

Next, a second non-limiting embodiment according to the automatic transmission of the invention will be explained referring to FIGS. 4 and 5. In addition, this second embodiment is different from the first embodiment in the arrangement place of the third control clutch, and is common to the first embodiment in other configurations. Accordingly, portions that are different from those of the first embodiment will be mainly explained below, and duplicate explanation of common members is omitted by giving the same reference numerals thereto.

Now, in the automatic transmission 10 of this embodiment, as shown in FIG. 4, in the dual planetary gear train 15 for speed reduction, the second ring gear R1 of the second planetary gear mechanism 22 is connected to the input shaft 14 so that the rotation of the input shaft 14 may be transmitted to the second ring gear R1. On the other hand, the second carrier C1 of the second planetary gear mechanism 22 in the dual planetary gear train 15 for speed reduction and the third ring gear R2 of the third planetary gear mechanism 23 in the dual planetary gear train 16 for speed change are detachably connected to each other by the third control clutch C-3. In addition, for the rest, as shown in FIG. 4, the respective members in the automatic transmission 10 are the same as those of the first embodiment.

Even in this second embodiment, the operating states at the time of speed change of the respective shift stages become as shown in the operation table of FIG. 2, similarly to the first embodiment. That is, in the forward third shift stage, the forward fourth shift stage, the forward sixth shift stage, and the forward seventh shift stage, the third control clutch C-3 operates. As a result, the second carrier C1 and the third ring gear R2 are connected to each other. In addition, even in the fifth shift stage, the third control clutch C-3 is not involved in torque (power) transmission although engaged.

Further, the rotation ratios of the respective sun gears S0 to S3, the respective carriers C0 to C3, and the respective ring gears R0 to R3 at the respective shift stages in a case where the rotational frequency of the input shaft 14 is defined as “11” are shown in the speed diagram of FIG. 5. Therefore, even in this second embodiment, the gear ratios of the forward eight stages and reverse two stages that are arrayed at proper intervals without any large variation in the rotation ratio, i.e., gear ratio of the fourth carrier C3 that is the third element at the respective shift stages, and that are separated suitably can be realized. Further, the step ratios that are increasing ratios of the gear ratios when the shift stage is raised by one stage become respective step ratios as shown in FIG. 2, similarly to the first embodiment.

Accordingly, even in the automatic transmission 10 of this second non-limiting embodiment, the same operation effects as the above (1) and (2) in the first embodiment can be exhibited. In addition, in this second embodiment, the third control clutch C-3 is provided between the second carrier C1 of the second planetary gear mechanism 22 in the dual planetary gear train 15 for speed reduction, and the third ring gear R2 of the third planetary gear mechanism 23 in the dual planetary gear train 16 for speed change.

### Third Embodiment

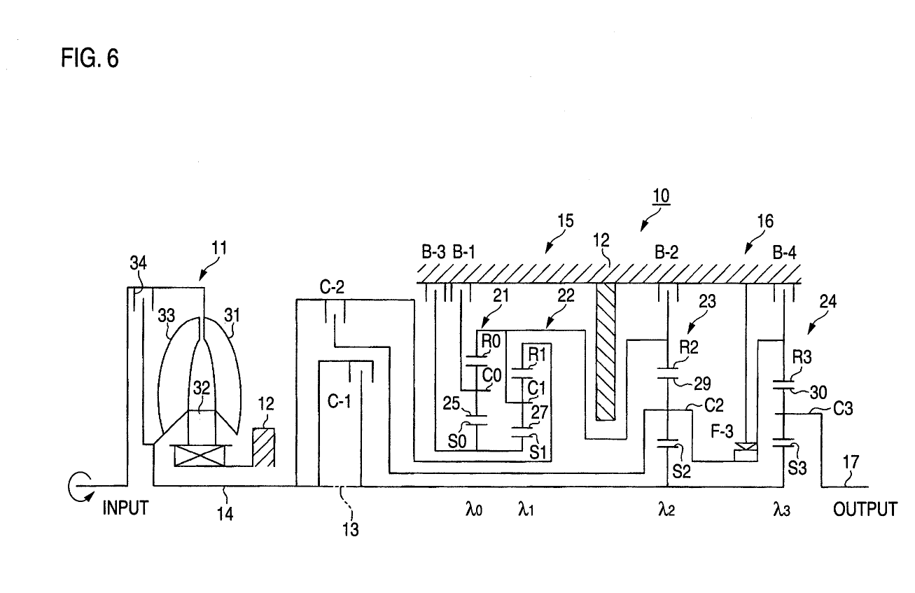

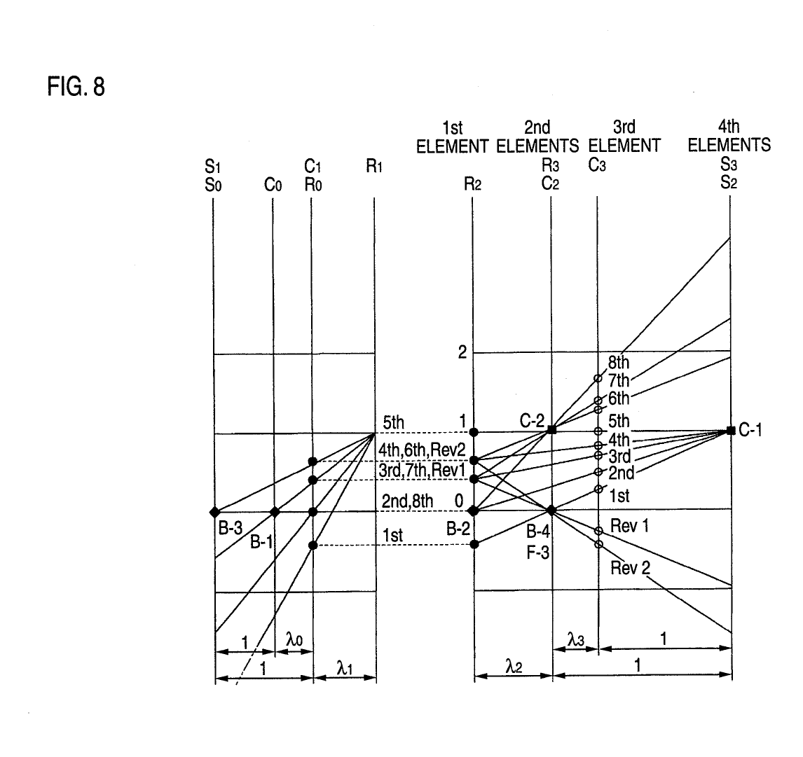

Next, a third non-limiting embodiment according to the automatic transmission of the invention will be explained referring to FIGS. 6 and 8. In addition, this third embodiment is different from the first embodiment in that it does not have the third control clutch, and is common to the first embodiment in other configurations. Accordingly, portions that are different from those of the first embodiment will be mainly explained below, and duplicate explanation of common members is omitted by giving the same reference numerals thereto.

Now, in the automatic transmission 10 of this embodiment, as shown in FIG. 6, in the dual planetary gear train 15 for speed reduction, the second ring gear R1 of the second planetary gear mechanism 22 is connected to the input shaft 14 so that the rotation of the input shaft 14 may be transmitted to the second ring gear R1. In addition, for the rest, as shown in FIG. 6, the respective members in the automatic transmission 10 are the same as those of the first embodiment.

Also, in this third embodiment, the operating states at the time of speed change of the respective shift stages does not have the third control clutch C-3 compared with the first embodiment. Therefore, the first ring gear R0 rotates at the forward first shift stage, the forward second shift stage, the forward eighth shift stage, the reverse first shift stage, and the reverse second shift stage, unlike the first embodiment.

That is, in these respective shift stages, the third ring gear R2 rotates reversely rotates according to the rotation of the third sun gear S2. However, the second carrier C1 that is connected to the third ring gear R2 also rotates reversely. Therefore, in a case where the third control clutch C-3 is not provided, the rotation of the input shaft 14 is transmitted even to the second ring gear R1, thereby causing a large relative rotational difference between the second ring gear R1 and the second carrier C1. As a result, the second sun gear S1 that meshes with the second pinion 27 that is provided by the second carrier C1 will rotate along the second sun gear S0 connected thereto. Also, the rotational speed of the first sun gear S0 and the second sun gear S1 in this case corresponds to the magnitude of the relative rotational difference between the second carrier C1 and the second ring gear R1. Accordingly, in the case of the forward first shift stage, the rotation at a highest speed will be made.

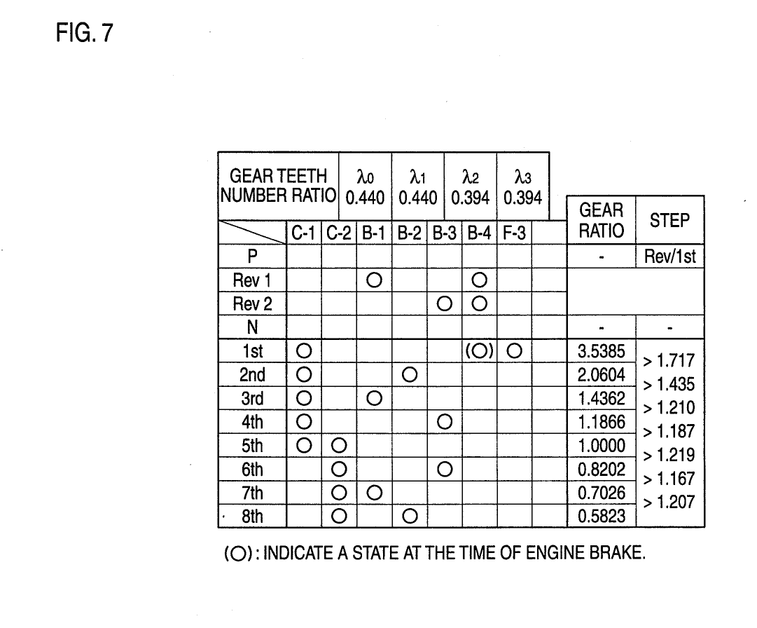

Further, the rotation ratios of the respective sun gears S0 to S3, the respective carriers C0 to C3, and the respective ring gears R0 to R3 at the respective shift stages in a case where the rotational frequency of the input shaft 14 is defined as “1” are shown in the speed diagram of FIG. 8. Therefore, even in this third embodiment, the gear ratios of the forward eight stages and reverse two stages that are arrayed at proper intervals without any large variation in the rotation ratio, i.e., gear ratio of the fourth carrier C3 that is the third element at the respective shift stages, and that are separated suitably can be realized. Further, the step ratios that are increasing ratios of the gear ratios when the shift stage is raised by one stage become respective step ratios as shown in FIG. 7, similarly to the first embodiment.

Accordingly, even in the automatic transmission 10 of this third embodiment, the same operation effect as the above (1) in the first embodiment can be exhibited.

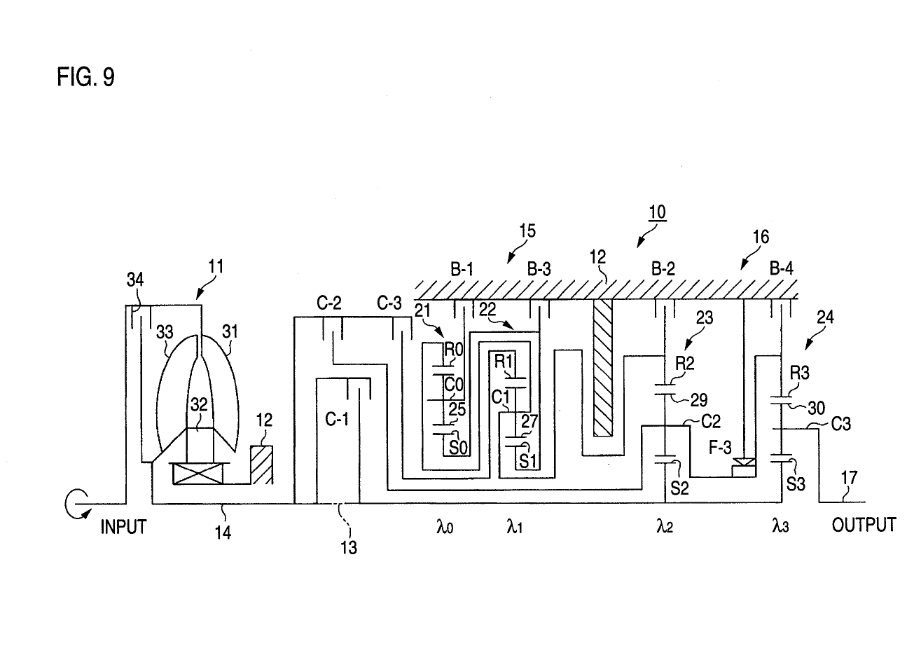

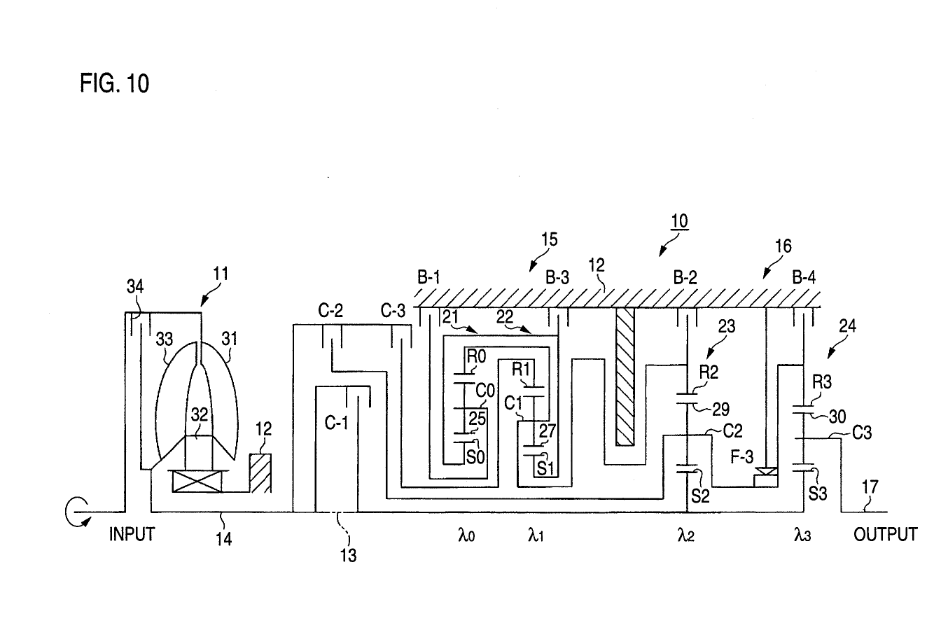

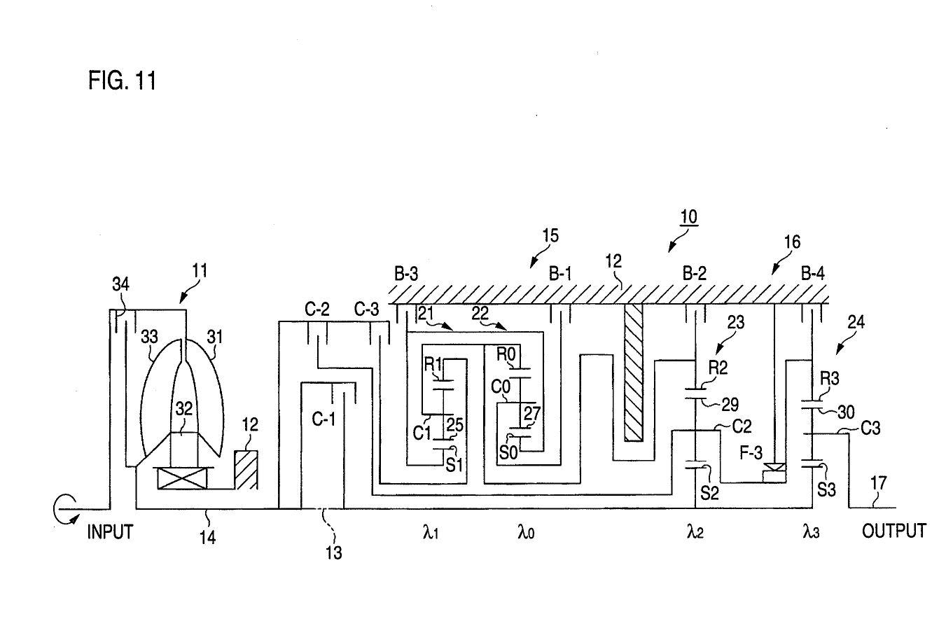

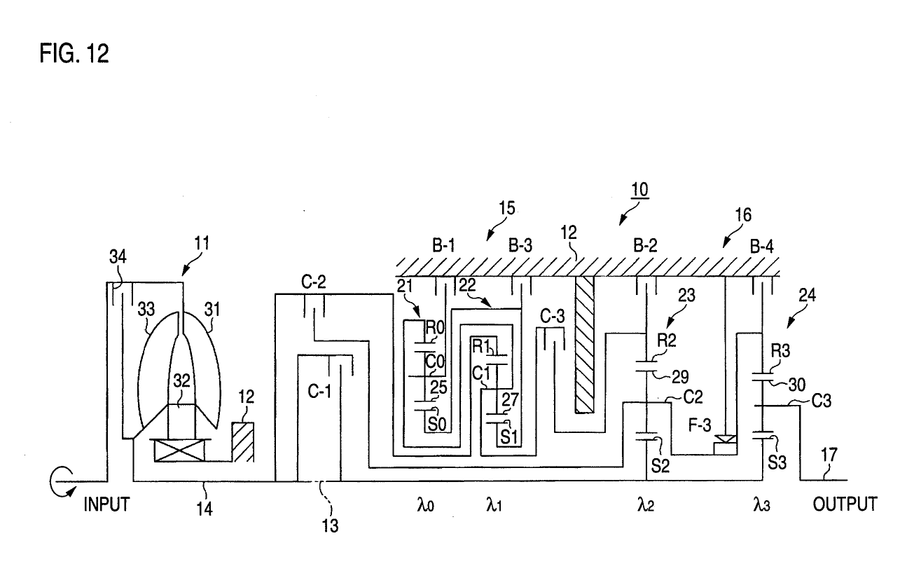

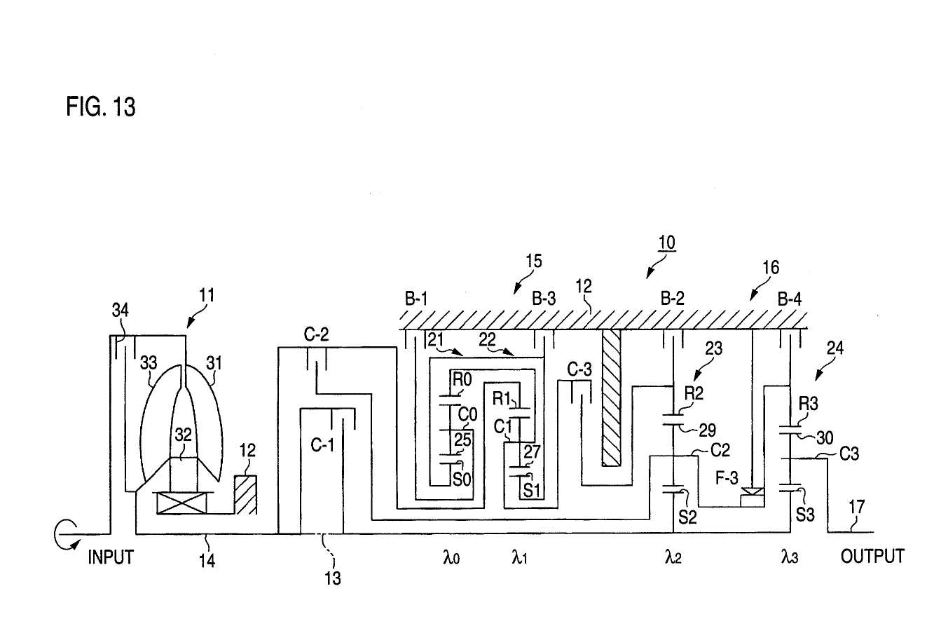

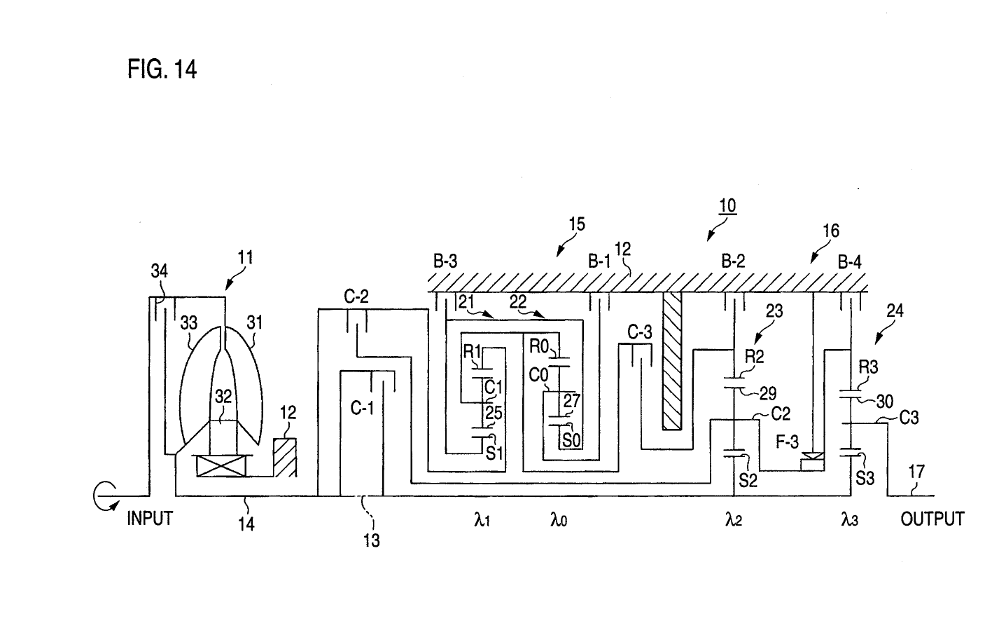

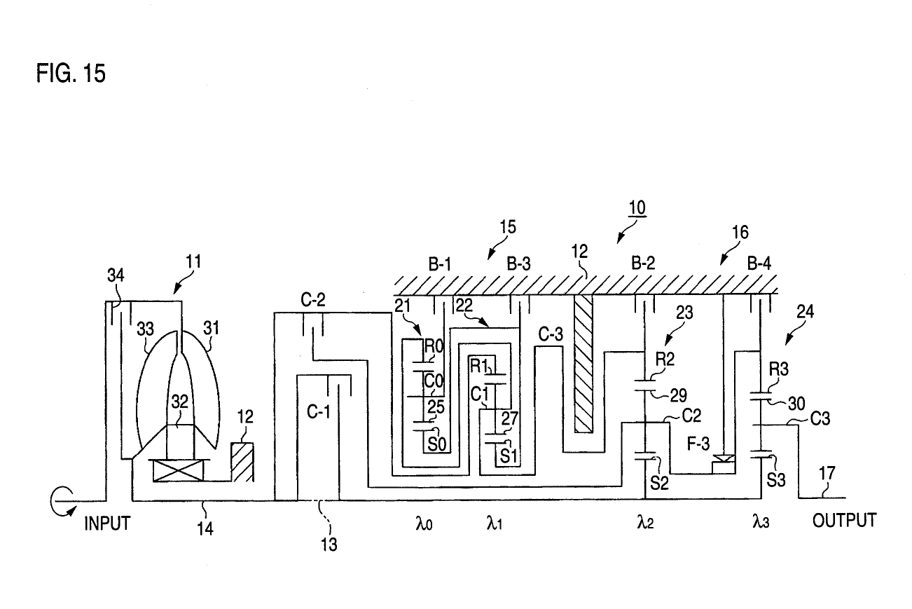

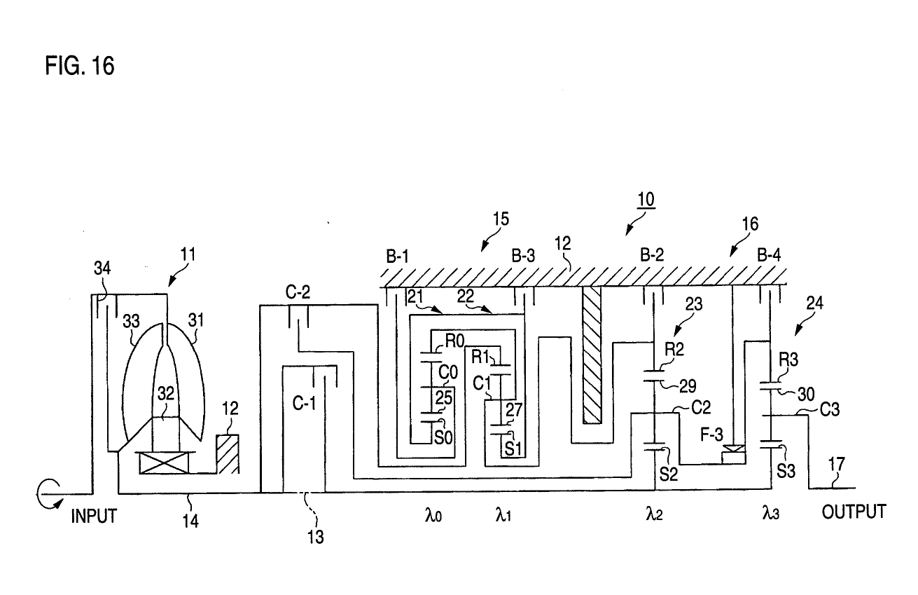

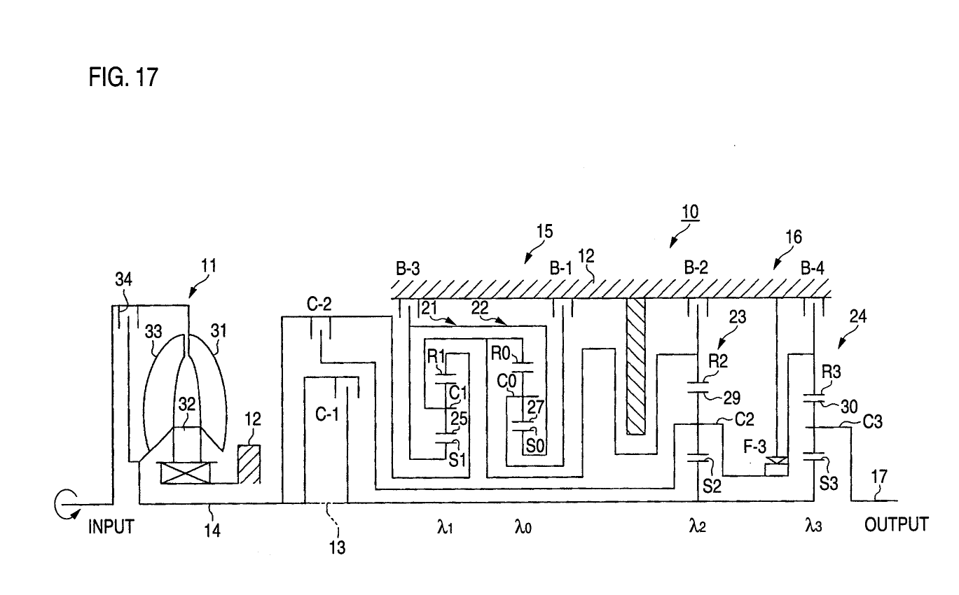

In addition, the above non-limiting embodiments may be modified to other following non-limiting embodiments (other examples).
In regard to the above first non-limiting embodiment, the extension aspect of hubs that extend in order to connect or link the respective sun gears S0, S1, the respective carriers C0, C1, the respective ring gears R0, and R1 in the first planetary gear mechanism 21 and the second planetary gear mechanism 22 of the dual planetary gear train 15 for speed reduction, to other elements, may be modified as shown in FIGS. 9 to 11. According to the automatic transmission 10 shown in FIGS. 9 to 11, suitable measures can be taken even in a case where the interval between the third control brake B-3 and the first control brake B-1 is different from that of the automatic transmission 10 of the first embodiment shown in FIG. 1.
In regard to the above second non-limiting embodiment, the extension aspect of hubs that extend in order to connector link the respective sun gears S0, S1, the respective carriers C0, C1, the respective ring gears R0, and R1 in the first planetary gear mechanism 21 and the second planetary gear mechanism 22 of the dual planetary gear train 15 for speed reduction, to other elements, may be modified as shown in FIGS. 12 to 14. According to the automatic transmission 10 shown in FIGS. 12 to 14, suitable measures can be taken even in a case where the interval between the third control brake B-3 and the first control brake B-1 is different from that of the automatic transmission 10 of the second embodiment shown in FIG. 4.
In regard to the above third non-limiting embodiment, the extension aspect of hubs that extend in order to connect or link the respective sun gears S0, S1, the respective carriers C0, C1, the respective ring gears R0, and R1 in the first planetary gear mechanism 21 and the second planetary gear mechanism 22 of the dual planetary gear train 15 for speed reduction, to other elements, may be modified as shown in FIGS. 15 to 17. According to the automatic transmission 10 shown in FIGS. 15 to 17, suitable measures can be taken even in a case where the interval between the third control brake B-3 and the first control brake B-1 is different from that of the automatic transmission 10 of the third embodiment shown in FIG. 6.

In the above respective non-limiting embodiments, if the respective gear tooth numbers λ0, λ1, λ2, and λ3 shown in the respective operation table of FIGS. 2 and 7, are satisfied, the numbers of teeth of the respective sun gears S0 to S3 and respective ring gear R0 to R3 in the respective planetary gear mechanisms 21 to 24 can be set arbitrarily.
In the above second non-limiting embodiment shown in FIG. 4, and the other non-limiting embodiments shown in FIGS. 12 to 14, the concrete arrangement place of the third control clutch C-3 may be arbitrary so long as the third control clutch can detachably connect the second ring gear R1 and the third ring gear R2 to each other.
In the above first non-limiting embodiment shown in FIG. 1, the second non-limiting embodiment shown in FIG. 4, and the other non-limiting embodiments shown in FIGS. 9 to 14, the engagement relationships of the third control clutch C-3 and the first control brake B-1 at the respective shift stages, which are shown by black circles in the operation table of FIG. 2, may be non-operating state.

The previous description of the exemplary non-limiting embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein, but is to be accorded the widest scope as defined by the limitations of the claims and equivalents thereof.

1. An automatic transmission comprising:
a dual planetary gear train for speed reduction having a first planetary gear mechanism and a second planetary gear mechanism both of which are of a single pinion type, and
a dual planetary gear train for speed changing having a third planetary gear mechanism and a fourth planetary gear mechanism both of which are of a single pinion type,
wherein, the first planetary gear mechanism comprises:
a first sun gear,
a first carrier that bears a first pinion that meshes with the first sun gear, and
a first ring gear that meshes with the first pinion,
wherein, the second planetary gear mechanism comprises:
a second sun gear that is connected to the first sun gear,
a second carrier that bears a second pinion that meshes with the second sun gear, and that is connected to the first ring gear, and
a second ring gear that meshes with the second pinion, the second ring gear being connected to an input shaft to transmit power thereto,
wherein, the third planetary gear mechanism comprises:
a third sun gear,
a third carrier that bears a third pinion that meshes with the third sun gear, and
a third ring gear that meshes with the third pinion, and is connected to both the second carrier and the first ring gear to transmit power thereto,
wherein the fourth planetary gear mechanism comprises:
a fourth sun gear,
a fourth carrier that bears a fourth pinion that meshes with the fourth sun gear, and
a fourth ring gear that meshes with the fourth pinion, and is connected to the third carrier,
wherein, the third sun gear is connected to the fourth sun gear and are detachably connected to the input shaft by a first control clutch,
wherein, the third carrier is detachably connected to the input shaft by a second control clutch, and the fourth carrier is connected to an output shaft, and
wherein, the rotation of the first ring gear and the second carrier is transmitted to the third ring gear.

2. The automatic transmission according to claim 1, further comprising a third control clutch for preventing a high-speed rotation of the first sun gear and the second sun gear.

3. The automatic transmission according to claim 2,
wherein, the third control clutch selectively connects the input shaft and the second ring gear.

4. The automatic transmission according to claim 2,
wherein, the third control clutch selectively connects the first ring gear to the third ring gear and the second carrier to the third ring gear.

5. The automatic transmission according to claim 1, wherein the first sun gear and the second sun gear are connected to a third control brake, and the first carrier is connected to a first control brake, and
wherein, the third ring gear and the fourth ring gear are connected to a second control brake and a fourth control brake, respectively.

6. The automatic transmission according to claim 2, further comprising a transmission case,
wherein, within the transmission case, the dual planetary gear train for speed reduction is provided between the third control clutch and the dual planetary gear train for speed changing.

7. The automatic transmission according to claim 2, further comprising a transmission case,
wherein, within the transmission case, the third control clutch is provided between the dual planetary gear train for speed reduction and the dual planetary gear train for speed changing.

8. The automatic transmission according to claim 7, wherein the third control clutch is provided between the second carrier and the third gear ring.

9. The automatic transmission according to claim 2, wherein the third control clutch selectively connects the second ring gear to the third ring gear.
